(19) United States
(12) Patent Application Publication
(10) Pub. No.: US 2010/0083958 A1
(43) Pub. Date: Apr. 8, 2010

(54) PERSONAL PROTECTIVE HOOD HAVING THERMOPLASTIC NECKDAM

(75) Inventors: Steven M. Lloyd, Smyrna, DE (US); Sunil Inamdar, Middletown, DE (US)

Correspondence Address: Novak, Druce & Quigg LLP, 1300 I Street, N.W., Suite 1000, West Tower, WASHINGTON, DC, 20005, US

(73) Assignee: ILC DOVER LP, Frederica, DE (US)

(21) Appl. No.: 12/561,652

(22) Filed: Sep. 17, 2009

Related U.S. Application Data
(60) Provisional application No. 61/098,151, filed on Sep. 18, 2008.

(51) Int. Cl. A62B 18/10; B29C 43/00; B29C 45/00; B29C 47/00

(52) U.S. Cl. 128/201.28; 264/299

(57) ABSTRACT

This invention relates to protective hoods, and in particular personal protective hoods which surround an individual's head and protects the individual from contact with Chemical-Biological-Radiological-Nuclear (CBRN), smoke, noxious fumes, and products of combustion, such as carbon monoxide. The protective hoods contain neck dams that seal against a person's neck and are formed from thermoplastic elastomers or polyolefins.

### CROSS-REFERENCE TO RELATED APPLICATIONS

The present application claims priority from U.S. Provisional Application Ser. No. 61/098,151, filed Sep. 18, 2008, entitled “Personal protective Hood Having Thermoplastic Neckdam,” the contents of which are herein incorporated by reference in their entirety.

### FIELD OF THE INVENTION

This invention relates to protective hoods, and in particular personal protective hoods which surround an individual's head and protects the individual from contact with Chemical-Biological-Radiological-Nuclear (CBRN), smoke, noxious fumes, and products of combustion, such as carbon monoxide.

### BACKGROUND OF THE INVENTION

Protective hoods, specifically personal protective equipment (PPE) hoods are known to protect a wearer's head from exposure to toxic chemicals, smoke, noxious fumes, and products of combustion such as carbon monoxide. Neckdams are commonly used in PPE hoods to create a seal of the hood to a person's neck. The neckdam is a transitional panel attached to the body of a hood with a hole in the center that creates a compression seal circumferentially around the wearer's neck, when the neckdam is stretched over a wearer's head.

Neckdams are typically manufactured from vulcanized rubber materials, either natural rubber or silicon rubber. These rubber materials function very well because of their excellent elastomeric properties and good chemical barrier properties. The elastomeric properties of the neckdam material not only provides a good neck seal, but also allows for head rotation and movement by stretching and distorting without compromising the seal to the neck. It also provides a chemical barrier when challenged with both liquids and vapors.

Examples of such neckdams can be found in U.S. Pat. No. 4,620,538, U.S. Pat. No. 6,158,429 and U.S. Pat. No. 6,892,725 B2 all assigned to the United States of America as represented by the Secretary of the Air Force (or Army) respectively. These patents are herein incorporated by reference in their entirety.

In investigating failures of present hoods, he present inventors have found that when protective hoods, such as PPE hoods, have failed the failure is attributable to the bonding of the hood material with the neckdam. Not only are the rubber materials typically used in neckdams costly to produce and difficult to assemble to the hood material itself, but also the vulcanized rubbers do not easily lend themselves to heat sealing to the typical hood materials, such as inexpensive thermoplastic films.

In the past, there have been attempts to improve the seals between hoods and rubber neckdams by providing a primer to the vulcanized rubber neckdams in order to provide a better bonding to the thermoplastic materials from which the hood itself is constructed. While such primers are an improvement over the previous attempts to bond thermoplastic hood materials directly to vulcanized rubber neckdams, failure of the PPE hoods still occur at the hood/neckdam interface e.g. in the failure of the primer, or the primer to neckdam/hood seal, to maintain a seal between the thermoplastic hood and the vulcanized rubber neckdam. This occurred despite the use of adhesives to attempt to integrate the thermoplastic hood material with the vulcanized rubber neckdam. Even in the presence of primers that promote adhesion there have still been failures of the neckdam seal. It is apparent that once the seal fails not only is the wearer's head, but also the wearer's eyes and entire pulmonary system, including nasal and throat passages as well as the wearer's lungs and potentially the wearer's blood system will be exposed to the environment such as smoke, noxious fumes, and products of combustion, such as carbon monoxide, which could result in injury and or death.

Thus, there is a continuing need for protective hoods with improved neckdam/hood integrity and especially in the field of PPE hoods with improved integrity of the seal between the hood material and the neckdam itself.

### BRIEF SUMMARY OF THE INVENTION

The present invention is directed to thermoplastic neckdams that have comparable performance to vulcanized rubber for protective hood applications such as PPE hood applications. The thermoplastic material of the neckdam has similar elastomeric, physical and chemical barrier properties when compared to vulcanized rubber material. These thermoplastic neckdams can be injection molded, compression molded or cut from extruded flat sheeting material resulting in easier-to-produce and thus, lower cost neckdams. Thermoplastic neckdams can also be heat sealed directly to inexpensive hood materials like polyethylene, thereby reducing not only the labor required to install the neckdam into the hood assembly but providing improved integrity of the neckdam/hood interface avoiding the heretofore noticed failures of prior art hood devices.

The overall result of the invention is a significantly lower cost neckdam and PPE hood assembly with better integrity than prior art PPE hoods.

### BRIEF DESCRIPTION OF THE DRAWINGS

FIG. 1 is a photograph of a typical PPE hood with the improved neckdam of the current invention shown in proximity to a wearer's head and neck.

FIG. 2 is a perspective view of a thermoplastic neckdam according to the present invention.

FIG. 3 is a top view of the neckdam according to the present invention.

FIG. 4 is a sectional view of FIG. 3 taken along lines 4-4.

FIG. 5 is an enlarged view of a portion of FIG. 4.

FIG. 6 is an enlarged view of a portion of FIG. 5.

FIG. 7 is an enlarged view of a portion of FIG. 5 to show details of neckdam elements.

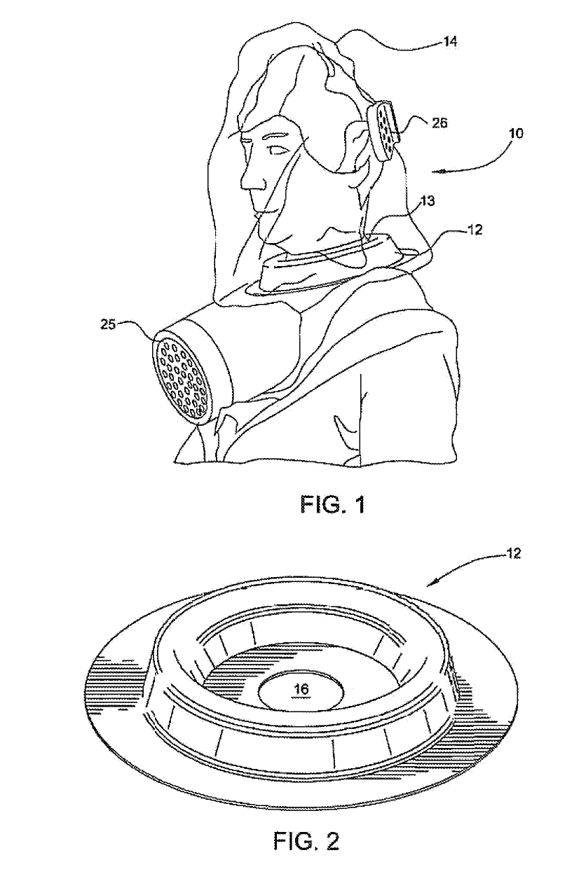

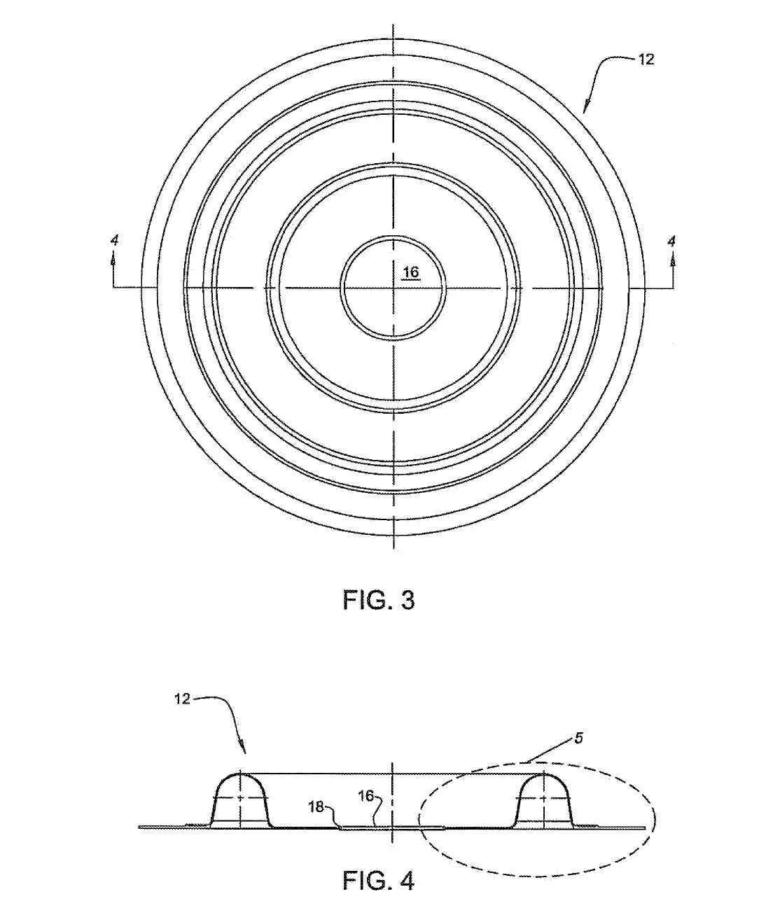

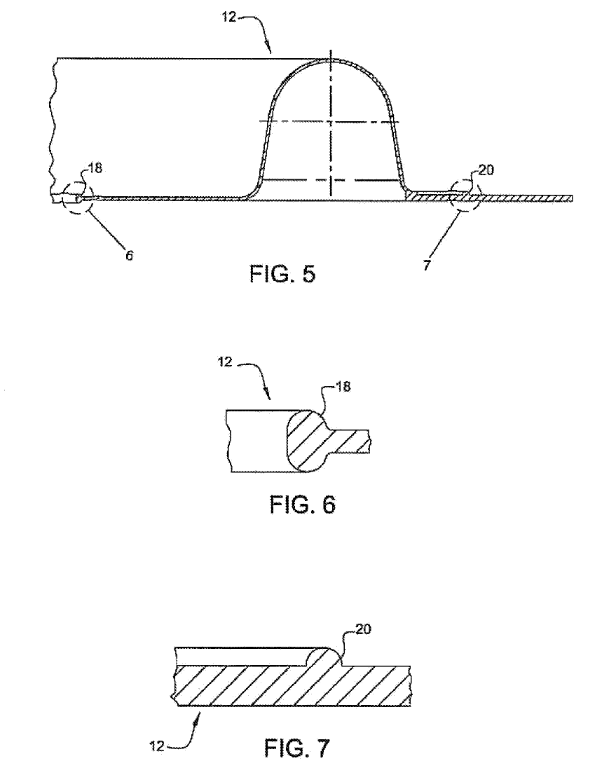

### DETAILED DESCRIPTION OF THE PRESENT INVENTION

Applicants have discovered that previous PPE hoods fail at the neckdam/hood interface, thereby exposing the wearer to external environments, such as toxic chemicals, smoke, noxious fumes, and products of combustion, such as carbon monoxide. While the prior art neckdams were formed of a vulcanized rubber material having certain desirable properties, such as a compression seal around an individual's neck, which also allows for head rotation and movement by stretching and distorting without compromising the seal to the neck, applicants have discovered that certain thermoplastic materials can be substituted for a vulcanized rubber neckdam without compromising either the compression seal 13 to the wearer's neck while also providing better integrity in sealing the neckdam to the thermoplastic materials usually associated with PPE hoods 10. Such thermoplastic materials for PPE hoods 10 generally have a sealant outer layer or a plurality of outer layers which are typically made of a transparent film or a plurality of layers of transparent films where the film or films are based on polyolefins not limited to polyethylene and/or other transparent polymers, such as acrylic or (meth)acrylic polymers, including (meth)acrylate and methyl (meth)acrylate materials, and other polymers having transparent properties to permit the wearer of the hood to see beyond the surface of the hood material. The foregoing examples of typical hood materials are in no way limiting, but are only meant to exemplify the properties of typical PPE hoods 10. Applicants have provided thermoplastic neckdams 12 which can be directly heat sealed to the thermoplastic hood 14 materials thus avoiding the use of adhesives and/or adhesives and primers as has been used in the prior art. Direct bonding of thermoplastic hoods to thermoplastic neckdams can be effected by heat sealing, sonic welding, friction welding, and other forms of applying pressure and/or heat simultaneously to create a weld between the thermoplastic hood 14 material and the thermoplastic neckdam 12.

While the thermoplastic hood 14 materials can normally be made by extrusion blow/molding techniques, they can also be formed by casting, injection/blow molding and other ways of shaping thermoplastic films.

On the contrary, the thermoplastic neckdams 12 of the present invention are usually formed by injection or compression molding and can still be directly sealed to the thermoplastic hood material. The aperture 16 in the neckdam 12 will still stretch over the wearer's head and still form a tight seal 13 with the neck even during head rotation without compromising the seal 13. Details of the periphery 18 of the neckdam 12 which forms seal 13 are shown in the enlarged view of FIG. 6. Details of the bonding surface of neckdam 12 are shown in FIG. 7 at 20. Forming the neck dams using these methods will orient the polymeric chains of the thermoplastic material used to appropriately form the neck dam.

In order to provide the elastomeric properties of the vulcanized rubber neckdams of the prior art the thermoplastic neckdam material Applicants have provided Table 1 which is a comparison of neckdam material's typical physical properties of the vulcanized rubber neckdam and thermoplastic neckdam material.

TABLE # 1
Comparison of Neckdam Materials Physical Properties

| | | Vulcanized Rubber | | Thermoplastic | |
|---|---|---|---|---|---|
| | | Neckdam Material | | Neckdam Material | |
| | | Machine | Transverse | Machine | Transverse |
| Property | Units | Direction | Direction | Direction | Direction |
| Mechanical | | | | | |
| Property | | | | | |
| ASTM 412 | | | | | |
| Thickness | Inches | 0.018 | 0.02 | 0.0275 | 0.0275 |
| Strain @ yield | % | 32 | | 807 | 314 |
| Stress @ yield | PSI | 56 | 85 | 542 | 180 |
| Force @ yield | Lb | 0.3 | 0.4 | 3.7 | 1.2 |
| Force 100% | Lb | 0.3 | 0.3 | 0.4 | 1 |
| Stress 100% | PSI | 72 | 65 | 66 | 139 |
| Force 200% | Lb | 0.5 | 0.5 | 0.6 | 1.1 |
| Stress 200% | PSI | 105 | 95 | 95 | 166 |
| Force 300% | Lb | 0.7 | 0.7 | 0.9 | 1.2 |
| Stress 300% | PSI | 153 | 144 | 129 | 169 |
| Ultimate Force | Lb | 5.9 | 5.8 | 4.3 | 1.4 |
| Ultimate Stress | PSI | 1268 | 1136 | 632 | 198 |
| Ultimate Strain | % | 795 | 800 | 879 | 526 |
| Puncture | | | | | |
| Resistance | | | | | |
| Load | Lbs | 9.7 | | 12.8 | |
| Elongation | % | 3.9 | | 3.5 | |
| Die B Tear | | | | | |
| Peak Load | Lb | 0.9 | 1 | 1.3 | 1.1 |
| Lbs/in Load | Lb/in | 40 | 39 | 47 | 39 |
| Shore A | | 21 | 21 | 25 | 25 |
| Durometer | | | | | |
| Flame test | | pass | | pass | |
| IAW NIOSH | | | | | |
| CBRN APER | | | | | |
| ASTM | | | | | 29 |
| Blocking test | | | | | |

While it can be seen that the thermoplastic neckdam 12 is slightly thicker than vulcanized rubber neckdam materials, they have a higher puncture resistance and comparable elongation. They are slightly better in tear resistance than the vulcanized rubber neckdam materials of the prior and each pass a flame test which makes them excellent materials for PPE hood applications.

The comparison of these properties permits a wide variation of polymer compositions to be used in preparing the thermoplastic neckdams of the present invention. By simple blending, adjustment of molecular weight, selection of polymer materials variation in dimensions of the neckdam and other techniques known to those skilled in the art it will be possible to achieve the properties of thermoplastic neckdam materials as set forth in the foregoing Table 1.

While not intending to be limited to any particular polymeric material, the neckdam 12 can be a blend of various polyolefins like polyethylene (linear low density polyethylene, low density polyethylene, high density polyethylene, metallocene grade polyethylenes), polypropylene (random, atatic, syndiotactic and metallocene grades) and/or thermoplastic elastomers comprising copolymers like Ethylene Propylene Diene Monomer (EPDM), Styrene Ethylene Butadiene Styrene (SEBS), Styrene Butadiene Styrene (SBS), Styrene Ethylene Ethylene Butadiene Styrene (SEEBS), Styrene isoprene Styrene (SIS) and other similar polymers.

These polymers can exist as homo- or co-polymers or blends and be compounded in the presence other additives such as thermal stabilizers, pigments, extenders, slip additives, flow enhancers, and the like.

The filter on ventilator 25 and exhaust valve 26 are conventional and are shown for exemplary purposes only.

Thus, while this disclosure exemplifies various polymeric materials, blends, and modifications which have the properties necessary for thermoplastic neckdams to be a component of a PPE hood 10, the foregoing disclosure is exemplary only and not limiting of the present invention, as other modifications and alternatives will become apparent to those skilled in the art to which the invention pertains upon reading this disclosure.

We claim:

1) A neck dam comprising:
an annular object of thermoplastic material that contains an aperture, wherein a periphery of the aperture is configured to form a seal with a human neck, and an annular raised portion of the annular object surrounds the aperture, and the annular raised portion transitions to an outer edge.

2) The neck dam of claim 1, wherein the neck dam is created from polyolefins, wherein the polyolefins include at least polyethylene, linear low density polyethylene, low density polyethylene, high density polyethylene, metallocene grade polyethylenes, random polypropylene, atactic polypropylene, syndiotactic polypropylene, metallocene grades

3) The neck dam of claim 1, wherein the neck dam is created from thermoplastic elastomers, wherein the thermoplastic elastomers include at least copolymers Ethylene Propylene Diene Monomer, Styrene Ethylene Butadiene Styrene, Styrene Butadiene Styrene, Styrene Ethylene Ethylene Butadiene Styrene, and Styrene Isoprene Styrene.

4) The neckdam of claim 1, wherein the neckdam is created from a blend of polyolefins and thermoplastic elastomers.

5) The neck dam of claim 1, wherein polymeric chains of the thermoplastic material are oriented by injection molding, compression molding, or extrusion.

6) The neck dam of claim 1, wherein a portion of the annular object is planar between the aperture and the annular raised portion.

7) A protective hood comprising:
a hood, wherein the hood is configured to encase a human head and is created out of a material that prevents exposure to the environment;
a neck dam, wherein the neck dam is an annular object of thermoplastic material that contains an aperture, wherein the aperture forms an inner periphery, wherein the inner periphery is configured to form a seal with a human neck, and an outer edge of the annular object forms a second periphery that is sealed to the hood.

8) The neck dam of claim 7, wherein the neck dam contains an annular raised portion that surrounds the aperture and transitions to the outer edge.

9) The neck dam of claim 8, wherein a portion of the neck dam is planar between the aperture and the annular raised portion

10) The protective hood of claim 7, wherein the neck dam is created from polyolefins wherein the polyolefins include at least polyethylene, linear low density polyethylene, low density polyethylene, high density polyethylene, metallocene grade polyethylenes, random polypropylene, atactic polypropylene, syndiotactic polypropylene, metallocene grades.

11) The protective hood of claim 7, wherein the neck dam is created from thermoplastic elastomers, wherein the thermoplastic elastomers include at least copolymers Ethylene Propylene Diene Monomer, Styrene Ethylene Butadiene Styrene, Styrene Butadiene Styrene, Styrene Ethylene Ethylene Butadiene Styrene, and Styrene Isoprene Styrene.

12) The protective hood of claim 7, wherein the hood is created from a single film, a plurality of layers of film, and alternatively with at least one sealant layer made from polyolefins including polyethylene, acrylic or meth-acrylic polymers.

13) The protective hood of claim 7, wherein the seal between the neck dam and the hood is a heat seal, a sonic weld, or a friction weld.

14) The protective hood of claim 7, wherein the neck dam is created using injection molding, compression molding, or extrusion.

15) The protective hood of claim 7, wherein the hood contains at least one ventilator or exhaust valve.

16) A method of making a neck dam comprising:
creating an annular object of thermoplastic material that contains an aperture, wherein the periphery of the aperture is configured to form a seal with a human neck and wherein the annular object contains an annular raised portion that surrounds the aperture and transitions to an outer edge.

17) The method of claim 16, wherein the outer edge of the annular object is configured to form a seal with a protective hood.

18) The method of claim 16, wherein the step of creating is on of injection molding, compression molding, or extrusion.

19) The method of claim 16, wherein the annular object is created from polyolefins wherein the polyolefins include at least polyethylene, linear low density polyethylene, low density polyethylene, high density polyethylene, metallocene grade polyethylenes, random polypropylene, atactic polypropylene, syndiotactic polypropylene, metallocene grades.

20) The method of claim 16, wherein the annular object is created from thermoplastic elastomers, wherein the thermoplastic elastomers include at least copolymers Ethylene Propylene Diene Monomer, Styrene Ethylene Butadiene Styrene, Styrene Butadiene Styrene, Styrene Ethylene Ethylene Butadiene Styrene, and Styrene Isoprene Styrene.

21) The method of claim 16, wherein the step of creating further comprises the annular object having a portion that is planar between the aperture and the annular raised portion.
